(19) United States
(12) Patent Application Publication
(10) Pub. No.: US 2017/0142734 A1
(43) Pub. Date: May 18, 2017

(54) APPARATUS AND METHOD FOR CONTROLLING INTERFERENCE BETWEEN SMALL-CELL BASE STATIONS BY USING MULTI-ANTENNA BEAMFORMING

(71) Applicants: ELECTRONICS AND TELECOMMUNICATIONS RESEARCH INSTITUTE, Daejeon-si (KR); UNIST(ULSAN NATIONAL INSTITUTE OF SCIENCE AND TECHNOLOGY), Ulsan-si (KR)

(72) Inventors: Hye Kyung JWA, Daejeon-si (KR); Hyun Jong YANG, Ulsan-si (KR); Jee Hyeon NA, Daejeon-si (KR); Jung Mo MOON, Daejeon-si (KR); Mu Yong SHIN, Daejeon-si (KR); Dong Seung KWON, Daejeon-si (KR); Myeung Un KIM, Busan-si (KR); Youjin KIM, Incheon-si (KR)

(21) Appl. No.: 15/355,602

(22) Filed: Nov. 18, 2016

(30) Foreign Application Priority Data
Nov. 18, 2015 (KR) 10-2015-0162153
Nov. 18, 2016 (KR) 10-2016-0154043

(51) Int. Cl. H04W 72/08; H04L 5/00; H04B 7/06; H04W 72/04

(52) U.S. Cl. CPC H04W 72/082; H04W 72/046; H04L 5/0048; H04L 5/0073; H04B 7/0617; H04B 7/0626

(57) ABSTRACT

An apparatus and method for controlling interference between small-cell base stations by using multi-antenna beamforming. The apparatus includes a channel state information (CSI) estimator, a non-optimal beamforming factor calculator, an optimal beamforming factor calculator, and an interference controller. The apparatus and method control interference between small-cell base stations by calculating an optimal beamforming factor assuming that information exchange between base stations is limited in a small-cell downlink system and each base station knows only a channel value sent by itself or a channel value received by itself.

### CROSS-REFERENCE TO RELATED APPLICATION(S)

This application claims priority from Korean Patent Application Nos. 10-2015-0162153, fled on Nov. 18, 2015, 10-2016-0154043, filed on Nov. 18, 2016, in the Korean Intellectual Property Office, the disclosure of which is incorporated herein by reference in its entirety.

### BACKGROUND

1. Field

The following description relates to a beamforming technology for a multi-antenna base station to reduce inter-cell interference in a downlink small-cell mobile communication system, and more particularly, to an apparatus and method for controlling interference between small-cell base stations by using multi-antenna beamforming.

2. Description of Related Art

Multi-antenna and small-cell techniques are attracting attention as core technologies required to increase a transmission rate in next-generation mobile communication.

In particular, according to the small-cell technique, small base stations are densely installed to reduce the distance between a user terminal and a base station. In this way, a channel gain is increased, and as a result, a system transmission rate is increased.

However, with an increase in cell density, interference between small cells increases. Therefore, to maximize the transmission rate of a small-cell system, it is necessary to solve the problem of inter-cell interference.

The multi-antenna technology is a core technology for increasing a transmission rate or reducing interference by using a beamforming technology. According to the multi-antenna technology, when unlimited information exchange is enabled between base stations, it is possible to detect an optimal beamforming scheme assuming that all communication nodes know all channel state information (CSI) (e.g., global CSI, etc.).

However, this assumption of global CSI includes an assumption that all base stations should know even a channel between a base station in a neighboring cell and a user terminal in the neighboring cell, and thus is hard to be used in practice.

Also, a backhaul having a limited transmission rate and limited delay performance generally exists between base stations, and the amount of information that can be exchanged between base stations is very limited.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to an apparatus and method for controlling interference between small-cell base stations by using multi-antenna beamforming which control interference between small-cell base stations by calculating an optimal beamforming factor assuming that information exchange between base stations is limited in a small-cell downlink system and each base station knows only a channel value sent by itself and a channel value received by itself.

In one general aspect, an apparatus for controlling interference between small-cell base stations by using multi-antenna beamforming includes: a channel state information (CSI) estimator configured to estimate the CSI of nearby base stations by using a pilot signal; a non-optimal beamforming factor calculator configured to set a degree of interference effects on base stations other than a base station to be optimized to 1 by using the CSI and calculate a non-optimal beamforming factor; an optimal beamforming factor calculator configured to calculate an optimal beamforming factor of the base station to be optimized, which maximizes a total achievable sum-rate of the base stations, by using the calculated non-optimal beamforming factor; and an interference controller configured to control interference by using the calculated optimal beamforming factor.

According to an exemplary embodiment, a weighted minimum-generating interface (Min-GI) scheme may be used for interference control.

According to an exemplary embodiment, when a signal-to-noise ratio (SNR) increases, performance resulting from the interference control may be improved.

According to an exemplary embodiment, an SNR may be maintained at 3 dB or higher to maximize performance.

In another general aspect, a method of controlling interference between small-cell base stations by using multi-antenna beamforming includes: estimating the CSI of nearby base stations by using a pilot signal; setting a degree of interference effects on base stations other than a base station to be optimized to 1 by using the CSI and calculating a non-optimal beamforming factor; calculating an optimal beamforming factor of the base station to be optimized, which maximizes a total achievable sum-rate of the base stations, by using the calculated non-optimal beamforming factor; and controlling interference by using the calculated optimal beamforming factor.

According to an exemplary embodiment, a weighted Min-GI scheme may be used for interference control.

According to an exemplary embodiment, when an SNR increases, performance resulting from the interference control may be improved.

According to an exemplary embodiment, an SNR may be maintained at 3 dB or higher to maximize performance.

Other features and aspects will be apparent from the following detailed description, the drawings, and the claims.

### BRIEF DESCRIPTION OF THE DRAWINGS

FIG. 1 is a diagram illustrating a small-cell network system using an apparatus for controlling interference between small-cell base stations by using multi-antenna beamforming according to an exemplary embodiment of the present invention.

FIG. 2 is a block diagram of an apparatus for controlling interference between small-cell base stations by using multi-antenna beamforming according to an exemplary embodiment of the present Invention.

FIG. 3 is a graph showing a difference in performance between a case of using a weighted minimum-generating interface (Min-GI) scheme according to an exemplary embodiment of the present invention and a case of using another scheme.

FIG. 4 is a flowchart illustrating a method of controlling interference between small-cell base stations by using multi-antenna beamforming according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, exemplary embodiments of the present invention will be described in detail with reference to the accompanying drawings, such that those of ordinary skill in the art to which the present invention pertains can easily carry out the present invention. However, the present invention can be implemented in various different forms, and is not limited to the exemplary embodiments described herein.

To clearly describe the present invention, parts which are not related to descriptions will be omitted from the drawings, and like parts will be denoted by like reference numerals throughout the drawings.

Throughout this specification, when a certain part “includes” a certain component, it means that another component may be further included and other components are not excluded, unless otherwise defined.

Hereinafter, an apparatus and method for controlling interference between small-cell base stations by using multi-antenna beamforming according to exemplary embodiments of the present invention will be described.

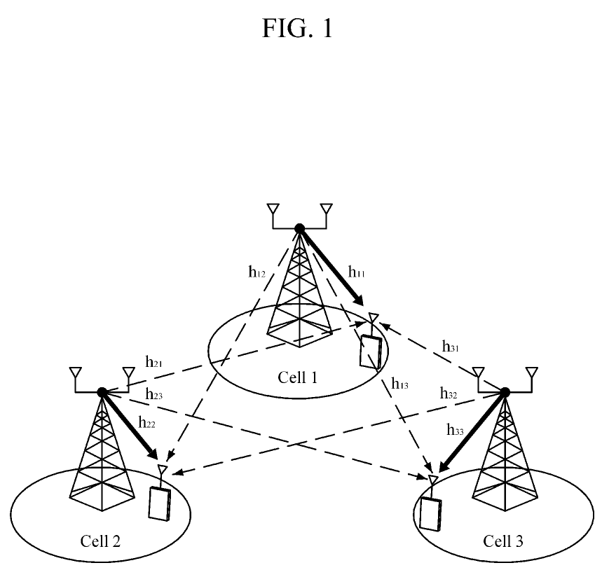

FIG. 1 is a diagram illustrating a small-cell network system using an apparatus for controlling interference between small-cell base stations by using multi-antenna beamforming according to an exemplary embodiment of the present invention.

Referring to FIG. 1, a system model of a small cell network (multiple-input single-output (MISO)) is shown. It is assumed that each base station is able to only know a channel value sent by itself and a channel value received by itself due to a limited transmission rate.

According to an exemplary embodiment in which there are N_{C} small cells and N_{T} antennas are in each small cell as shown in FIG. 1, when a channel vector of a signal transmitted from an i^{th} base station to a j^{th} user is hᵢⱼ and a beamforming vector at the i^{th} base station is wᵢ, a received signal at each small cell is as shown in Equation 1 below.

$${y}_{i} = {\underbrace{{h}_{ii}^{H} {w}_{i} {x}_{i}}}_{desired signal} + {\underbrace{{\sum }_{k = 1 , k \neq i}^{{N}_{C}} {h}_{ki}^{H} {w}_{k} {x}_{k}}}_{intercell interference} + {z}_{i} \qquad [ Equation 1 ]$$

Here, a signal-to-interference-plus-noise ratio (SINR) at the i^{th} small-cell base station is as shown in Equation 2 below, and a total achievable sum-rate at the i^{th} small-cell base station is as shown in Equation 3.

$$\begin{matrix}S I N {R}_{i} = \frac{{\vert {h}_{ii}^{H} {w}_{i} \vert}^{2}}{{\sum }_{k = 1 , k \neq i}^{{N}_{C}} {\vert {h}_{ki}^{H} {w}_{k} \vert}^{2} + {N}_{0}} & [ Equation 2 ] \\ R = {\sum }_{i = 1}^{{N}_{C}} log ( 1 + S I N {R}_{i } ) & [ Equation 3 ]\end{matrix}$$

According to an exemplary embodiment of the present Invention, the degree of interference effect may vary depending on a total achievable sum-rate at each small-cell base station. When the degree of interference effect is βᵢ, a weighted generating-interference (WGI) is as shown in Equation 4 below.

$${Ω}_{i} = {\sum }_{j = 1 , j \neq i}^{{N}_{C}} {β}_{ij} {\vert {h}_{ij}^{H} {w}_{i} \vert}^{2} , {\sum }_{j = 1 , j \neq i}^{{N}_{C}} {β}_{ij} = 1 \qquad [ Equation 4 ]$$

A beamforming vector for minimizing GI in Equation 4 may be designed as shown in Equation 5 below.

$${w}_{i}^{min - Interf} = min {Ω}_{i} ( w ) , s . t . {‖ {w}_{i} ‖}^{2} = 1 \\ {Ω}_{i} = {‖ [ \begin{matrix}\sqrt{{β}_{i 1}} {h}_{i 1}^{H} \\ ⋮ \\ \sqrt{{β}_{i ( i - 1 ) }} {h}_{i ( i - 1 ) }^{H} \\ \sqrt{{β}_{i ( i + 1 )}} {h}_{i ( i + 1 )}^{H} \\ ⋮ \\ \sqrt{{β}_{i {N}_{C}}} {h}_{i {N}_{C}}^{H}\end{matrix} ] {w}_{i} ‖}^{2} = {‖ {G}_{i} {w}_{i} ‖}^{2} \\ {G}_{i} ⊔ [ \begin{matrix}\sqrt{{β}_{i 1}} {h}_{i 1}^{H} \\ ⋮ \\ \sqrt{{β}_{i ( i - 1 ) }} {h}_{i ( i - 1 ) }^{H} \\ \sqrt{{β}_{i ( i + 1 )}} {h}_{i ( i + 1 )}^{H} \\ ⋮ \\ \sqrt{{β}_{i {N}_{C}}} {h}_{i {N}_{C}}^{H}\end{matrix} ] ∈ ⌋ ( {N}_{C} - 1 ) \times {N}_{T} \qquad [ Equation 5 ]$$

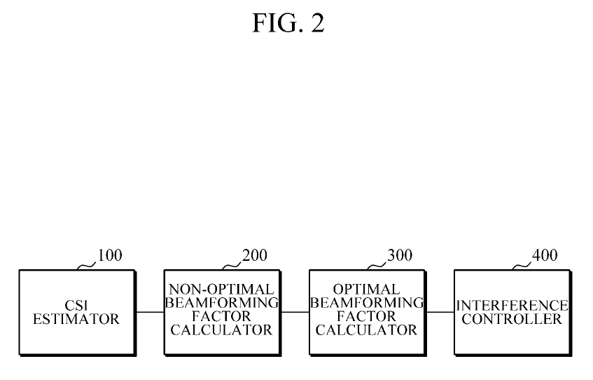

FIG. 2 is a block diagram of an apparatus 1000 for controlling interference between small-cell base stations by using multi-antenna beamforming according to an exemplary embodiment of the present invention.

Referring to FIG. 2, the apparatus 1000 for controlling interference between small-cell base stations by using multi-antenna beamforming may include a channel state information (CSI) estimator 100, a non-optimal beamforming factor calculator 200, an optimal beamforming factor calculator 300, and an interference controller 400.

The CSI estimator 100 may estimate the CSI of nearby base stations by using a plot signal.

According to an exemplary embodiment of the present invention, local CSI may be used as CSI.

The non-optimal beamforming factor calculator 200 may set the degree of interference effects on base stations other than a base station to be optimized to 1 by using the CSI and calculate a non-optimal beamforming factor.

Here, the non-optimal beamforming factor ŵⱼ may denote a beamforming vector of a j^{th} base station when β values are optimized for an i^{th} base station only and β values for other base stations are set to 1.

According to an exemplary embodiment of the present invention, a problem of maximizing a transmission sum-rate by using Equation 3 may be solved to determine a value of βᵢ. To this end, it is necessary for the i^{th} base station to know all SINRs of terminals belonging to other base stations. However, the i^{th} base station is able to know only channel values relating thereto from local CSI, and thus it is possible to design wₖ by considering an i^{th} channel only.

When only the i^{th} channel is taken into consideration, an SINR may be calculated as ρ in Equation 6 below.

$${ρ}_{i} = \frac{{\vert {h}_{ii}^{H} {w}_{i} \vert}^{2}}{{\sum }_{j = 1 , j \neq i}^{{N}_{C}} {\vert {h}_{ji}^{H} {\hat{w}}_{j} \vert}^{2} + {N}_{0}} \geq 0 , \\ {ρ}_{j} = \frac{{\vert {h}_{jj}^{H} {\hat{w}}_{j} \vert}^{2}}{\vert {h}_{ij}^{H} {w}_{i} \vert + {\sum }_{k = 1 , k \neq i , j}^{{N}_{C}} {\vert {h}_{ki}^{H} {\hat{w}}_{k} \vert}^{2} + {N}_{0}} \geq 0 , \qquad [ Equation 6 ]$$

ρⱼ in Equation 6 is calculated ac cording to ∥Gᵢwᵢ∥₂≦∥Ĝᵢŵᵢ∥₂ as shown in Equation 7 below.

$$\begin{matrix}{ρ}_{j} = \frac{{\vert {h}_{jj}^{H} {\hat{w}}_{j} \vert}^{2}}{{\vert {h}_{ij}^{H} {w}_{i} \vert}^{2} + {\sum }_{k = 1 , k \neq i , j}^{{N}_{C}} {\vert {h}_{k}^{H} {\hat{w}}_{k} \vert}^{2} + {N}_{0}} \\ \geq \frac{{\vert {h}_{jj}^{H} {\hat{w}}_{j} \vert}^{2}}{\frac{{‖ {\hat{G}}_{i} {\hat{w}}_{i} ‖}_{2}^{2}}{{β}_{ij}} + {\sum }_{k = 1 , k \neq i , j}^{{N}_{C}} {\vert {h}_{ki}^{H} {\hat{w}}_{k} \vert}^{2} + {N}_{0}} \\ = \frac{{β}_{ij} \cdot {\vert {h}_{jj}^{H} {\hat{w}}_{j} \vert}^{2}}{{‖ {\hat{G}}_{i} {\hat{w}}_{i} ‖}_{2}^{2} + {β}_{ij} \cdot {\sum }_{k = 1 , k \neq i , j}^{{N}_{C}} {\vert {h}_{ki}^{H} {\hat{w}}_{k} \vert}^{2} + {β}_{ij} \cdot {N}_{0}} \\ \geq \frac{{β}_{ij} \cdot {\vert {h}_{jj}^{H} {\hat{w}}_{j} \vert}^{2}}{{‖ {\hat{G}}_{i} {\hat{w}}_{i} ‖}_{2}^{2} + {β}_{ij} \cdot {\sum }_{k = 1 , k \neq i , j}^{{N}_{C}} {\vert {h}_{ki}^{H} {\hat{w}}_{k} \vert}^{2} + {β}_{ij} \cdot {N}_{0}} \\ \geq \frac{{β}_{ij} \cdot {\vert {h}_{jj}^{H} {\hat{w}}_{j} \vert}^{2}}{{‖ {\hat{G}}_{i} {\hat{w}}_{i} ‖}_{2}^{2} + {\sum }_{k = 1 , k \neq i , j}^{{N}_{C}} {\vert {h}_{ki}^{H} {\hat{w}}_{k} \vert}^{2} + {N}_{0}}\end{matrix} \qquad [ Equation 7 ]$$

The optimal beamforming factor calculator 300 may calculate an optimal beamforming factor of a base station to be optimized, which maximizes a total achievable sum-rate of the base stations, by using the calculated non-optimal beamforming factor.

Here, the optimal beamforming factor of the base station to be optimized may denote a beamforming vector wᵢ of the i^{th} base station which is a target for optimization.

According to an exemplary embodiment of the present invention, all base stations are able to mutually exchange their values |hₖ₁^{H}\dot{w}ₖ| to |h_{knc1}^{H}\dot{w}ₖ| obtained by using the calculated non-optimal beamforming vector.

Also, according to an exemplary embodiment of the present invention, Cⱼ may be calculated by using |hₖ₁^{H}\dot{w}ₖ| to |h_{knc1}^{H}\dot{w}ₖ| through Equation 8 below.

$${\sum }_{k = 1}^{{N}_{C}} log ( 1 + S I N {R}_{k} ) \geq {\sum }_{k = 1}^{{N}_{C}} log ( 1 + {ρ}_{k} ) \geq 0 + {\sum }_{j = 1 , j \neq i}^{{N}_{C}} log ( 1 + {β}_{ij} \cdot {C}_{j} ) \\ {C}_{j} = \frac{{\vert {h}_{jj}^{H} {\hat{w}}_{j} \vert}^{2}}{{‖ {\hat{G}}_{i} {\hat{w}}_{i} ‖}_{2}^{2} + {\sum }_{k = 1 , k \neq i , j}^{{N}_{C}} {\vert {h}_{ki}^{H} {\hat{w}}_{k} \vert}^{2} + {N}_{0}} \qquad [ Equation 8 ]$$

According to an exemplary embodiment of the present invention, βᵢⱼ, which maximizes the total achievable sum-rate, is calculated as shown in Equation 9 below by using the Karush-Kuhn-Tucker (KKT) conditions.

$${[ {β}_{ij} = γ - \frac{1}{{C}_{j}} ]}^{+} , {where [ χ ]}^{+} , max ( χ , 0 ) \\ γ satisfies {\sum }_{j = 1 , j \neq i}^{{N}_{C}} {β}_{ij} = 1 \qquad [ Equation 9 ]$$

By substituting βᵢⱼ obtained through this calculation process into Equation 5, it is possible to calculate the beamforming vector wᵢ of the i^{th} small-cell base station.

The interference controller 400 may control interference by using the calculated optimal beamforming factor.

According to an exemplary embodiment of the present invention, a weighted minimum-generating interface (Min-GI) scheme may be used for interference control.

According to an exemplary embodiment of the present Invention, when a signal-to-noise ratio (SNR) increases, performance resulting from the interference control may be improved.

According to an exemplary embodiment, the SNR may be kept at 3 dB or higher to maximize performance.

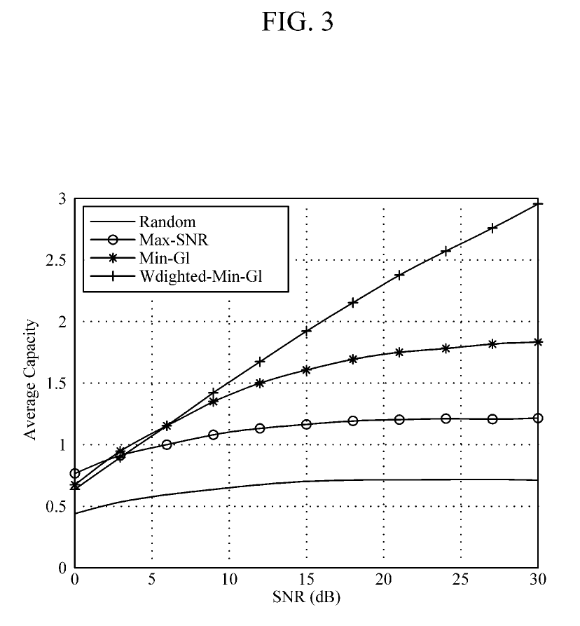

FIG. 3 is a graph showing a difference in performance between a case of using the weighted Min-GI scheme according to an exemplary embodiment of the present invention and a case of using another scheme.

Referring to FIG. 3, it is possible to see that the case of using the weighted Min-GI scheme shows higher performance than the case of using another scheme when the SNR is 3 dB or higher.

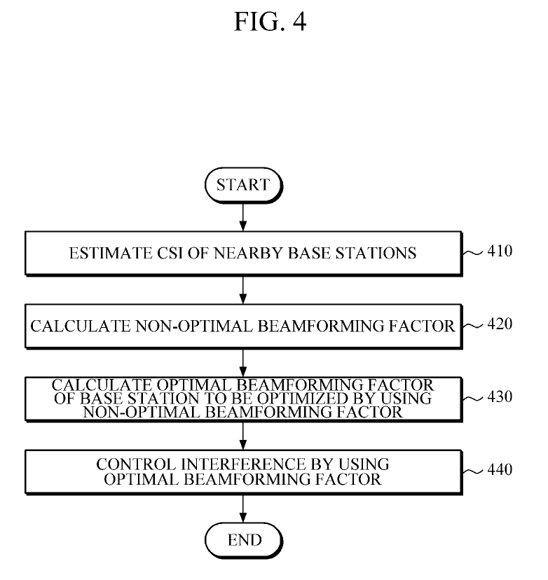

FIG. 4 is a flowchart illustrating a method of controlling interference between small-cell base stations by using multi-antenna beamforming according to an exemplary embodiment of the present invention.

The CSI of nearby base stations is estimated (410).

According to an exemplary embodiment of the present invention, it is possible to estimate the CSI of the nearby base stations by using a pilot signal.

According to an exemplary embodiment of the present Invention, local CSI may be used as the CSI.

A non-optimal beamforming factor is calculated (420).

According to an exemplary embodiment of the present invention, it is possible to set the degree of interference effects on base stations other than a base station to be optimized to 1 by using the CSI and calculate a non-optimal beamforming factor.

Here, a non-optimal beamforming factor ŵⱼ may denote a beamforming vector of a j^{th} base station when β values are optimized for an i^{th} base station only and β values for other base stations are set to 1.

According to an exemplary embodiment of the present invention, a problem of maximizing a transmission sum-rate by using Equation 3 may be solved to determine a value of βᵢ. To this end, it is necessary for the i^{th} base station to know all SINRs of terminals belonging to other base stations. However, the i^{th} base station is able to know only channel values relating thereto from local CSI, and thus it is possible to design wₖ by considering an i^{th} channel only.

When only the i^{th} channel is taken into consideration, an SINR may be calculated as ρ in Equation 6 above.

ρⱼ in Equation 6 is calculated according to ∥Gᵢwᵢ∥₂≦ƒĜᵢŵᵢ∥₂ as shown in Equation 7 above.

By using the non-optimal beamforming factor, a beamforming vector of the base station to be optimized is calculated (430).

According to an exemplary embodiment of the present invention, it is possible to calculate an optimal beamforming factor of the base station to be optimized, which maximizes a total achievable sum-rate of the base stations, by using the calculated non-optimal beamforming factor.

Here, the optimal beamforming factor of the base station to be optimized may denote a beamforming vector wᵢ of the i^{th} base station which is a target for optimization.

According to an exemplary embodiment of the present invention, all base stations are able to mutually exchange their values |hₖ₁^{H}\dot{w}ₖ| to |h_{knc1}^{H}\dot{w}ₖ| obtained by using the calculated non-optimal beamforming vector.

Also, according to an exemplary embodiment of the present invention, Cⱼ may be calculated by using |hₖ₁^{H}\dot{w}ₖ| to |h_{knc1}^{H}\dot{w}ₖ| through Equation 8.

According to an exemplary embodiment of the present invention, βᵢⱼ, which maximizes the total achievable sum-rate, may be calculated as shown in Equation 9 below by using the KKT conditions, and the beamforming vector wᵢ of the i^{th} small-cell base station may be calculated by substituting the obtained βᵢⱼ into Equation 5.

Interference may be controlled by using the calculated optimal beamforming factor (440).

According to an exemplary embodiment of the present invention, interference may be controlled by using the calculated beamforming factor.

According to an exemplary embodiment of the present invention, the weighted Min-GI scheme may be used for interference control.

According to an exemplary embodiment of the present invention, when an SNR increases, performance resulting from the interference control may be improved.

According to an exemplary embodiment, the SNR may be kept at 3 dB or higher to maximize performance.

According to exemplary embodiments of the present invention, an optimal beamforming vector is calculated by using the weighted Min-GI scheme to control interference between small-cell base stations. When an SNR is only higher than 3 dB, exemplary embodiments of the present invention may show better performance than a case of using another scheme. Therefore, it is possible to effectively reduce inter-cell interference through limited Information exchange alone, and a gain in performance increases with an increase in SNR.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for controlling interference between small-cell base stations by using multi-antenna beamforming, the apparatus comprising:
a channel state information (CSI) estimator configured to estimate CSI of nearby base stations by using a pilot signal;
a non-optimal beamforming factor calculator configured to set a degree of interference effects on base stations other than a base station to be optimized to 1 by using the CSI and calculate a non-optimal beamforming factor;
an optimal beamforming factor calculator configured to calculate an optimal beamforming factor of the base station to be optimized, which maximizes a total achievable sum-rate of the base stations, by using the calculated non-optimal beamforming factor; and
an interference controller configured to control interference by using the calculated optimal beamforming factor.

2. The apparatus of claim 1, wherein a weighted minimum-generating interface (Min-GI) scheme is used for the interference control.

3. The apparatus of claim 2, wherein, when a signal-to-noise ratio (SNR) increases, performance resulting from the interference control is improved.

4. The apparatus of claim 2, wherein a signal-to-noise ratio (SNR) is maintained at 3 dB or higher to maximize performance.

5. A method of controlling interference between small-cell base stations by using multi-antenna beamforming, the apparatus comprising:
estimating channel state information (CSI) of nearby base stations by using a pilot signal;
setting a degree of interference effects on base stations other than a base station to be optimized to 1 by using the CSI and calculating a non-optimal beamforming factor;
calculating an optimal beamforming factor of the base station to be optimized, which maximizes a total achievable sum-rate of the base stations, by using the calculated non-optimal beamforming factor; and
controlling interference by using the calculated optimal beamforming factor.

6. The method of claim 5, wherein a weighted minimum-generating interface (Min-GI) scheme is used for the interference control.

7. The method of claim 6, wherein, when a signal-to-noise ratio (SNR) increases, performance resulting from the interference control is improved.

8. The method of claim 6, wherein a signal-to-noise ratio (SNR) is maintained at 3 dB or higher to maximize performance.
